(19) United States
(12) Patent Application Publication
(10) Pub. No.: US 2016/0086114 A1
(43) Pub. Date: Mar. 24, 2016

(54) SERVICE-BASED CONSULTING FRAMEWORK

(71) Applicant: INFOSYS LIMITED, Bangalore (IN)

(72) Inventors: Venkata Murali Krishna, Bangalore (IN); Prabu Chinnaiyan, Bangalore (IN); Muralidhara Reddy, Bangalore (IN)

(73) Assignee: INFOSYS LIMITED, Bangalore (IN)

(21) Appl. No.: 14/845,008

(22) Filed: Sep. 3, 2015

(30) Foreign Application Priority Data
Sep. 22, 2014 (IN) 4594/CHE/2014

(51) Int. Cl. G06Q 10/06

(52) U.S. Cl. CPC G06Q 10/0637

(57) ABSTRACT

A system and method for providing end-to-end consulting activity is disclosed. The consulting system receives domain input from the user of the consulting system. Based on the domain selected, the system selects a methodology for consulting activity, comprising a template with a list of questionnaires. The questionnaire may be sent to respective stakeholders/consultants for providing response. The response provided by stakeholders may involve current state of the business, pain points and desired business capabilities. The consulting system determines gap between current state of business with desired state of business based by as-is, gap, and impact analysis. Business and functional requirement are converted into desired technical capabilities for generating technology roadmap using the stakeholder response. Further, request for information (RFI) and/or request for proposal (RFP) may be created as per client goals. The user may configure vendor evaluation parameters and associated weightages for evaluating the vendor.

### FIELD OF TECHNOLOGY

This disclosure relates generally to the field of consulting and, more particularly, to automating consulting engagements of an enterprise.

### BACKGROUND

Customer satisfaction is most important for the enterprise. Enterprises looking for complete assessment of current environment identify desired business and technical capabilities and identify an implementation vendor before moving. For example, contact center are moving towards IP based solutions that enable unified customer interaction environment across multiple channels such as voice, e-mail, and chat.

Consulting activities for business assessments are highly time consuming, at least in part because they are largely discovery based. A discovery based approach for conducting assessments uses consulting subject matter experts who are specialists in working with a client to understand their business and identify how they may improve it. A prescriptive based approach uses consultants having expertise identify the problems in a business and know the solutions to fix them through experience and knowledge. The market is now looking at the prescriptive approaches based upon best practices. Many of the steps in the activities for consulting assessments are manual, thus making standardization of the consulting process difficult.

In addition, data preparations, such as translating hypotheses into interview questionnaires, conducting interviews, and summarizing interview data, are very labor-intensive and lengthy in duration. Many assessments produce results that summarize the current business state rather than analyzing the data to provide new business insights and recommendations. The lack of standardization results in inconsistent data, complicating the process of data consolidation (i.e., combining data from various divisions or units in a business for the purpose of summarizing a larger partition of the business).

Tracking results and recommendations is difficult. Many clients are reluctant to engage consultants for assessment projects because of uncertainties regarding the deliverables as well as costs of follow-up assessments to monitor progress. For example, clients may typically engage consultants the first time to perform an assessment, but usually do not want to engage the consultants again for follow-up assessments. Clients often prefer to learn from the assessment process and then have the option of performing the assessment themselves.

Current solutions are typically monolithic, restrictive in its capabilities and do not provide flexible configuration and integration capabilities. Existing solutions don't have a flexibility to create customized reports, number of graphs and security features. None of the existing solutions provide the flexibility required to support end-to-end assessment activities. Therefore, there is a need for a tool to standardize and simplify the business assessment process.

### SUMMARY

Disclosed is a method, a framework and/or a system for providing end-to-end consulting activity for enterprises.

In one aspect, a consulting system receives a selection of domain or field of consulting from user. Based on the domain selected, the system selects a methodology for consulting activity. The methodology includes consulting plan comprising a template with a list of questions under different categories, document templates and structure for as-is (i.e. analysis of current situation), gap analysis, impact analysis, request for information (RFI) and/or request for proposal (RFP). The questionnaire may be sent to respective stakeholders and/or consultants for review. The response provided by stakeholders may involve current state of the business, pain points and desired business capabilities (DBC). The consulting system analyzes and determines gap between current state of business with desired state of business by as-is, gap and impact analysis. The stakeholder response may be used to convert business and functional requirement into desired technical capabilities (DBC) for generating technology roadmap. The user may configure vendor evaluation parameters and associated weightages. The vendor may be evaluated by score based on different functional parameters and the associated weightage.

In another aspect, the user is provided with option to perform cost benefit analysis by comparing different vendors.

In yet another aspect, the repository used in the consulting system comprises reusable methodologies with pre-defined questionnaire and templates. The repository can be updated for different areas and/or industries for example contact center, aerospace, automobile, banking, insurance etc.

In one aspect, the consulting system may be integrated with social media, email, short messaging service (SMS), fax, and chat through web.

In another aspect, the consulting system stores sensitive data in a database using secured encrypted storage mechanism.

In yet another aspect, the consulting system has authentication and authorization means to manage access and authenticate users. The user accounts may be configurable.

In one aspect, the consulting system supports hosted and/or in premise based solution. Also, the consulting system automates the activity by reducing the time taken in consultation.

### BRIEF DESCRIPTION OF THE DRAWINGS

Example embodiments are illustrated by way of example and not limitation in the figures of the accompanying drawings, in which like references indicate similar elements and in which:

FIG. 1 is an architecture diagram of consulting system, according to one embodiment.

FIG. 2 shows process diagram of the consulting system, according to one embodiment.

FIG. 3A-C shows detailed architecture diagram of the consulting system, according to one embodiment.

FIG. 4A-C shows context diagram of the consulting system, according to one embodiment.

FIG. 5A-B shows flowchart of data collection module, according to one or more embodiments.

FIG. 6A-B shows flowchart of planner module, according to one or more embodiments.

FIG. 7A-B shows flowchart of analysis module, according to one or more embodiments.

FIG. 8A-B shows flowchart of request for information (RFI) and/or request for proposal (RFP) module, according to one or more embodiments.

FIG. 9 shows a process flow diagram of consulting system, according to one embodiment.

Other features of the present embodiments may be apparent from the accompanying drawings and from the detailed description that follows.

### DETAILED DESCRIPTION

Example embodiments, as described below, may be used to provide a method, a framework or a system to provide end-to-end consulting activity. Although the present embodiments have been described with reference to specific example embodiments, it may be evident that various modifications and changes may be made to the embodiments without departing from the broader spirit and scope of the various embodiments. The framework or tool may be comprehensive with centralized real-time and/or historical reporting, dynamic consulting knowledge enabler tool. In short, one stop shop solution for all the consulting engagements.

The present technology may be directed to systems, methods, and framework to provide end-to-end consulting activity. The solution achieves 50% reduction in consultation time by automating the consulting activity. The current invention supports hosted or in-premise based solution for global reach.

The embodiments herein disclose a framework which leverages use of readymade and customized templates in each phase of consultation (as-is, request for information (RFI) and/or request for proposal (RFP), etc.), integration of media channels (e-mail, short messaging service(SMS), alerts and audio & video collaboration, well-defined weightage based methodology to evaluate vendors under different evaluation parameters and a repository of all re-usable consulting methodologies with a list of readily available questionnaire.

In one or more embodiments, consulting may be assisting enterprises to improve performance through analysis such as as-is, gap and impact analysis. The consulting process may develop future roadmap for enterprise development.

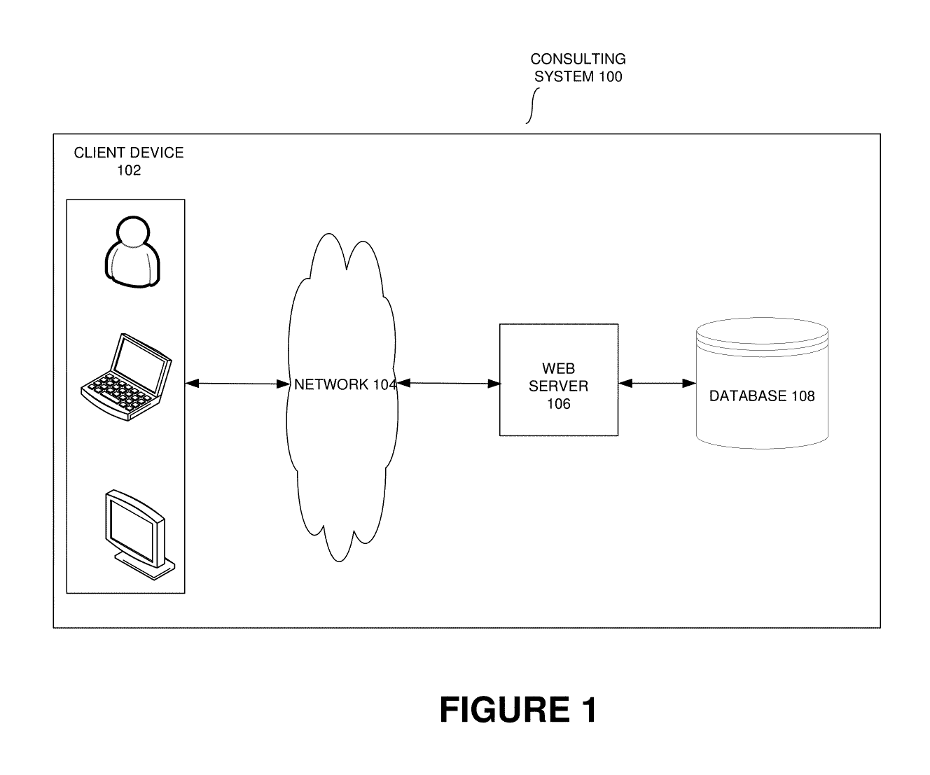

FIG. 1 refers to a consulting system 100. The consulting system 100 may broadly be described as including a web user interface (UI) layer 102, network 104, web server 106, and database 108. The web UI layer 102 may be consisting of a user laptop or desktop or mobile device. The web UI layer 102 may communicate to network 104 through hypertext transfer protocol secure (https) protocol. The web server 106 may be consisting of business core components of the consulting system 100.

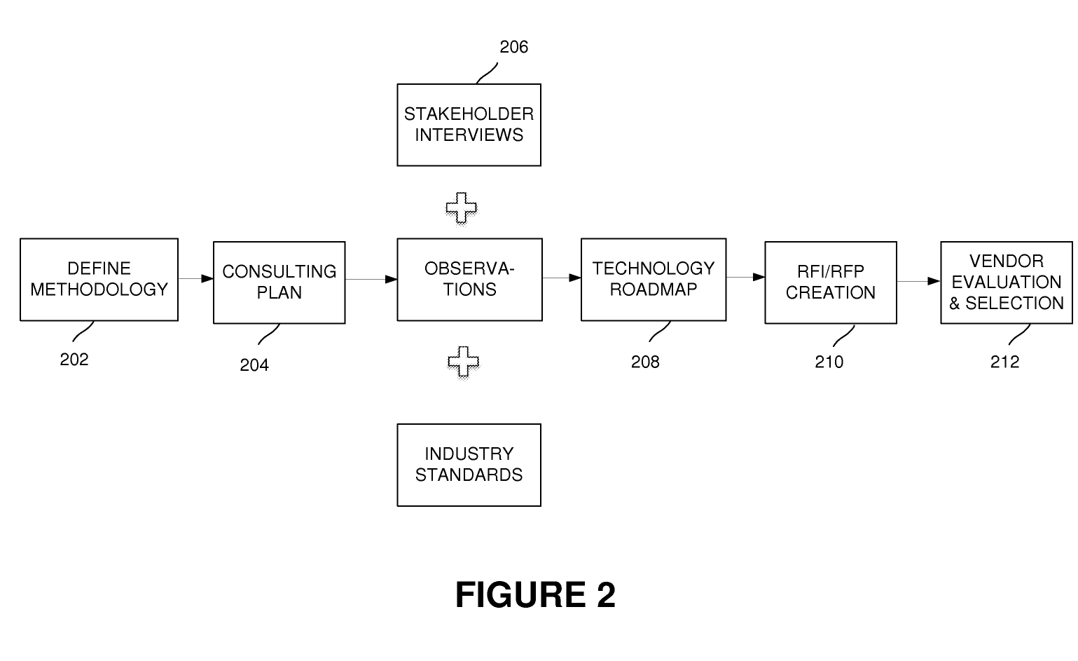

FIG. 2 illustrates process flow diagram of consulting system 100. The process of automating consulting activity may involve defining methodology 202 used in consulting based on client requirements. Once the methodology is defined, preparing a consulting plan comprising a template with a list of questionnaires 204. The consulting plan may be sent to respective stakeholders and/or consultants. The stakeholders and/or consultants may view the consulting plan and provide response 206. The response provided by stakeholders may involve current state of the business, pain points and desired business capabilities. The response may be used to convert business and functional requirement(s) into desired technical capabilities (DTC) to generate technology roadmap 208. Further, request for information (RFI) and/or request for proposal (RFP) may be created as per client goals 210. Vendor may be evaluated based on different functional parameters and associated weightage for each vendor 212.

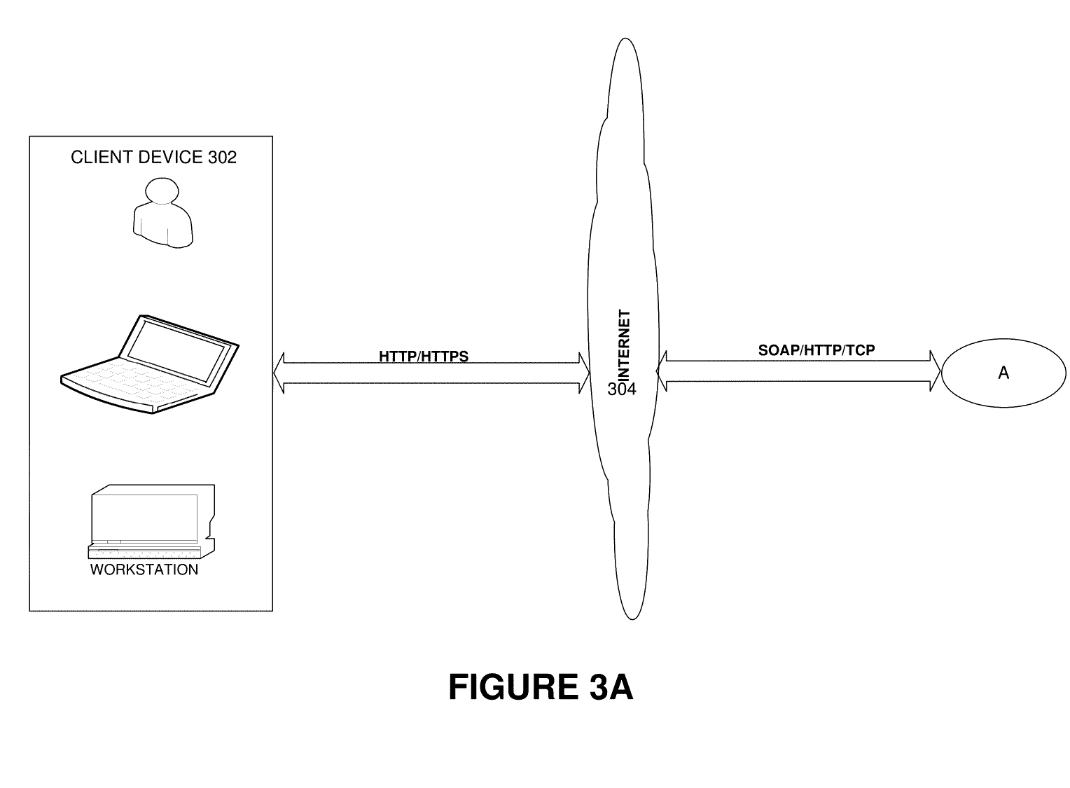

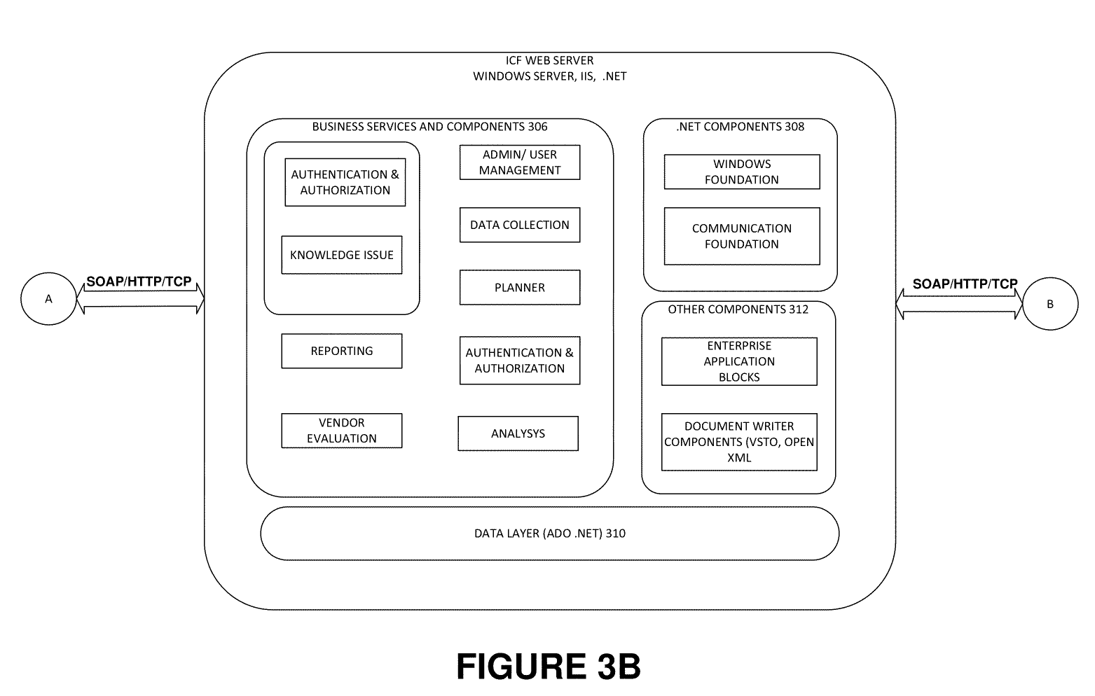

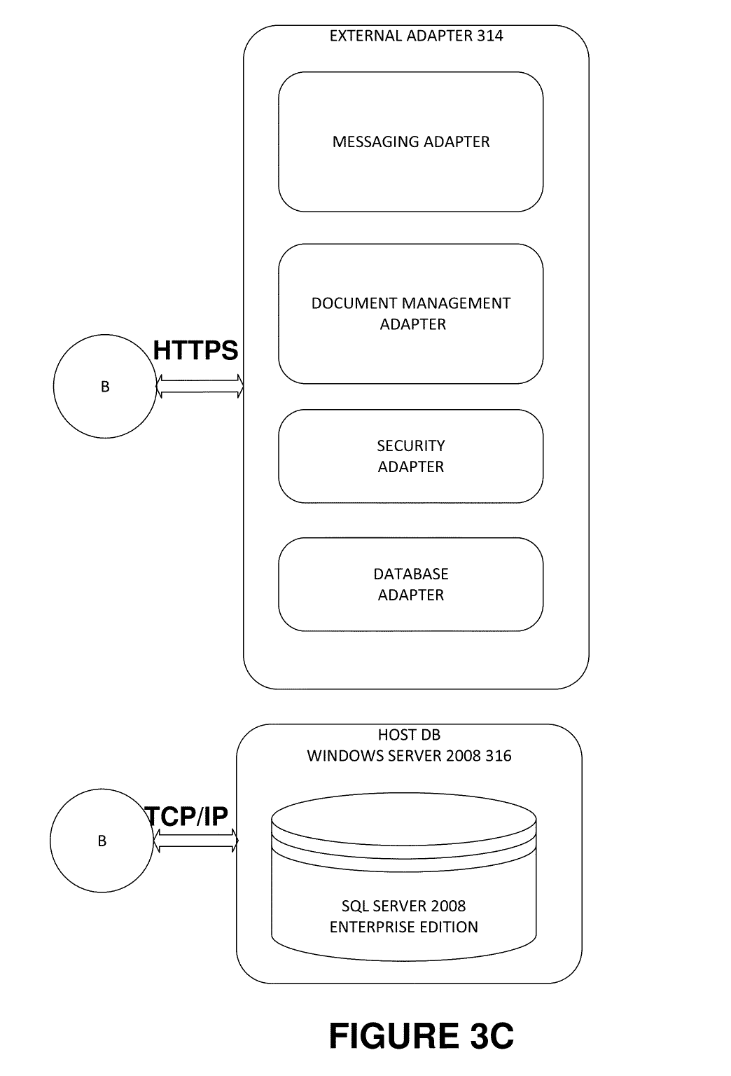

FIG. 3 shows consulting system architecture, according to one or more embodiments. The consulting system architecture may be an adapter based model. The client device 302 of the consulting system core block may use http/https protocols for interaction through internet 304 as well as with the database.

The consulting system block contains business service components 306 comprising core consulting components, .Net components 308 like workflow foundation, communication foundation etc., data layer 310 and other components 312 like enterprise application blocks, VSTO, interop and openXML etc. The source of external services may vary from client to client. The external adapter 314 model may be a channel to connect the consulting system with the external system. The consulting system of FIG. 3. illustrate host database (DB) 316 such as windows server.

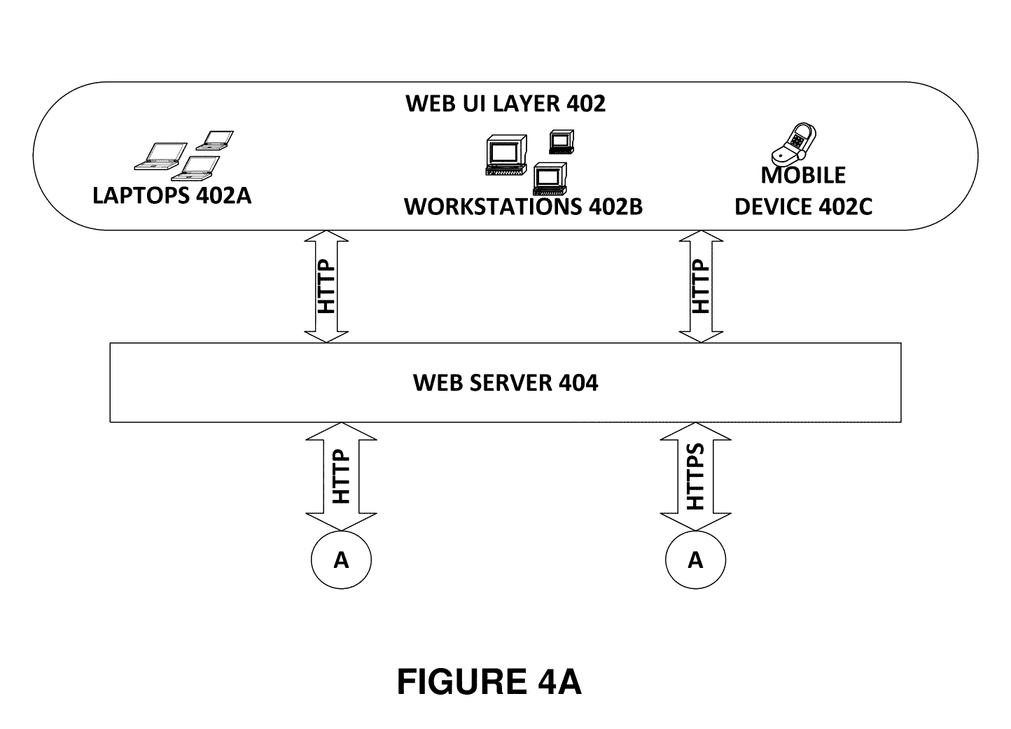

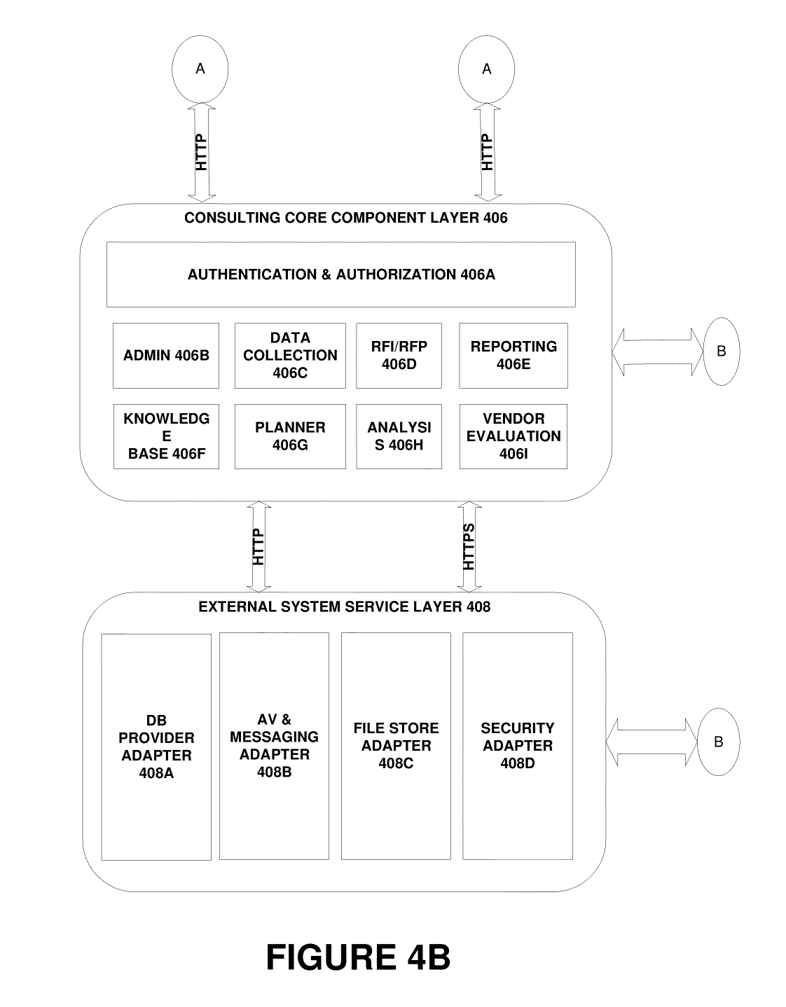

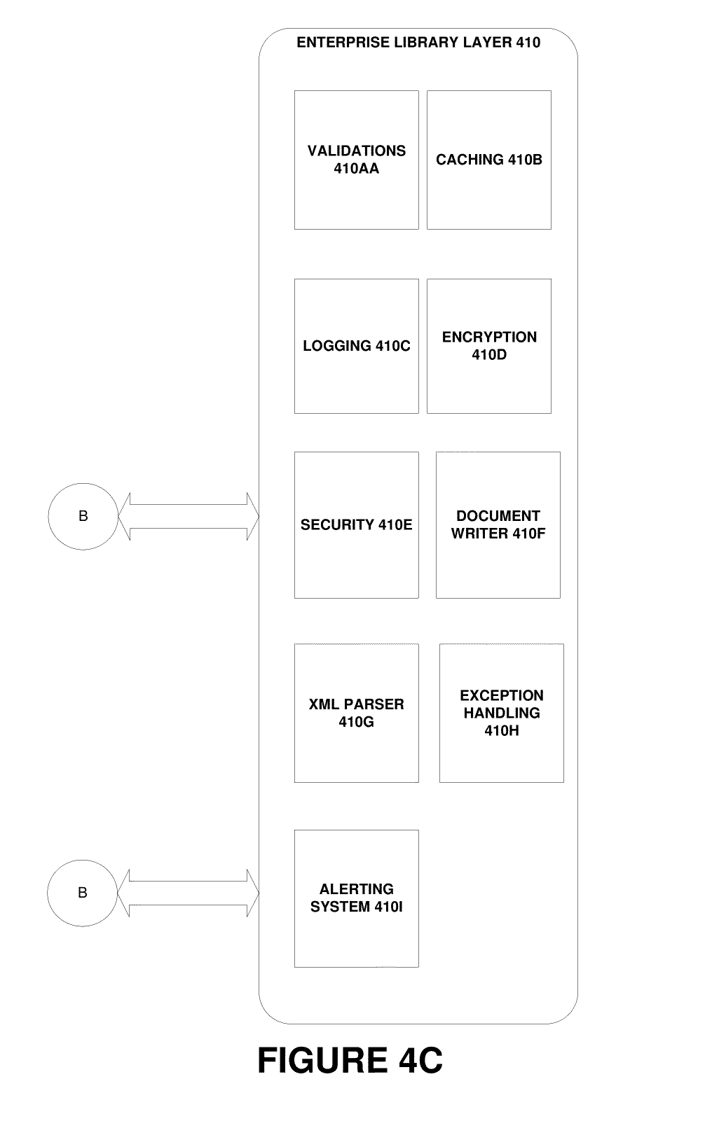

FIG. 4 describes logical view of the consulting system, consisting of the web UI layer 402, web server 404, consulting core components layer 406, external system service layer 408 and enterprise library layer 410. The web UI layer 402 represents the consumer used front end web page(s). Consumers may be able to interact with the system from devices such as laptop 402A, workstation 402B and mobile 402C. The web UI layer 402 may consist of lead consultant or consultant or stakeholder or customer views. The web server 404 may receive requests raised by the consumers. The web server 404 would then route the request to the core components of the consulting system 100. The consulting core components layer 406 may represent various core components handling the core engine for automating various consulting business workflows. The various core components may be authentication and authorization 406A, admin 406B, data collection 406C, RFI/RFP 406D, reporting 406E, knowledgebase 406F, planner 406G, analysis 406H and vendor evaluation 406I. The external systems service layer 408 may comprise of the pluggable services for various needs such as database (DB) provider 408A, audio video (AV) & messaging 408B, file store adapter 408C, and security adapter 408D etc. The external systems service layer components may interact using the respective adapters, providing standard interface to the consulting system 100 to use and encapsulates internals of the respective service implementations. The external systems service layer 408 may give flexibility to replace the respective services with alternate ones as appropriate (for e.g. replacing use of AV & messaging services from vendor A to vendor B). The various adapters in the external system service layer 408 may be the DB provider adapter 408A, AV & messaging adapter 408B, file store adapter 408C, and security adapter 408D. The enterprise library layer 410 may comprise of the helper components meeting cross cutting needs of the consulting system 100. The components in the enterprise library layer may be validation 410A, caching 410B, logging 410C, encryption 410D, security 410E, document writer 410F, extensible markup language (XML) parser 410G, exception handling 410H, and alerting 410I.

In one or more embodiments, the authentication and authorization module 406A of the consulting core component layer may be used to authenticate the user. The users may be authenticated based on the credentials provided by the user as input and may be authorized to view based on user groups (admin, stakeholder, consultant and vendor etc.). The component internally uses security provider service of the external service system layer.

The admin component 406B of the consulting core component layer may be used to control user and the external system. The admin 406B may use the module to add, modify, delete or configure the user, user group and vendors. The admin may add and/or delete projects and allocate or de-allocate users to a particular project. The admin may configure the database, log details (name, location etc.), parameters for vendor evaluation and media channel information. The document templates required in the consulting system 100 may be contained in the knowledgebase 406F. The admin may add and/or edit and/or delete the knowledgebase 406F as and when needed. The methodologies may be prepared on receiving client requirements as inputs. The admin prepares questions related to the stakeholders, domain and vendor specific functionality. The template for documents such as status reports, DBC, DTC, etc. may be prepared by the admin.

The planner module 406G of the consulting core component layer may be used to define the consulting methodology, modify and store the modified methodology for future reference. The planner module 406G may be used for consulting planning, execution and tracking i.e. keeping track of the overall progress of the end-to-end consulting exercise. The methodologies defined in the knowledgebase 406E may be the input for the planner 406G. Based on the input received (methodology), activities for the selected methodology may be listed. The user may select multiple activities, for example entering the details like start date, end date (both actual and planned date) and the owner of the activity for each activity. The user may be able to generate a plan and send the plan to a list of stakeholders and/or consultants. All the stakeholders and/or consultants may view and provide comments. The user may update the plan and store the plan in central storage post approval.

The data collection module 406C of the consulting core component layer may be used to collect the data from multiple stakeholders, current state, pain points and DBCs. The DBC may be used to convert business and functional requirement into the DTC s. The user selects the project and stakeholder type. Based on the selection, the list of questions may be populated. The questionnaire may be sent to the stakeholders. The response to the questions may be used to prepare question and answer (Q&A) document. The DBC document may be generated from Q&A after a process of voting and prioritizing by the stakeholder.

The request for information (RFI) and/or request for proposal (RFP) 406D module may be used to prepare RFI and RFP as per the client goals, priorities and based on information received from the clients and stakeholders on the capabilities and products.

The DBC document generated in the data collection module may be used to prepare DTC document. The analysis module 406H of consulting core component layer may conduct gap and impact analysis of the enterprise.

The vendor evaluation module 406I of the consulting core component layer may be used to evaluate a vendor on different functional parameters and the associated weightage for each vendor. The vendor evaluation module 406I generates a dashboard illustrating summary of the vendors evaluated. The vendors may be evaluated based on the different evaluation parameters (technical, commercial, brand value, program management capabilities) and consultant ratings. The module 406I may generate draft version of the vendor evaluation document based on the responses from different vendors. The vendor evaluation may be done based on the question and response process in the data collection module.

The reporting module 406E of the consulting core components layer may create custom report e.g. vendor based report, technology pricing based reporting, business & technical functionalities wise report etc.

In one or more embodiments, the validation block 410A of the enterprise library layer may be used by application developers to implement structured and easy to maintain validation scenarios in the application.

The enterprise library caching application block 410B may provide a local cache in applications. The caching application block 410B may support both an in-memory cache and, optionally, a backing store that could either be the database store or isolated storage. The caching application block 410B may be used without modification; it provides all the functionality needed to retrieve, add, and remove cached data. Configurable expiration and scavenging policies may also be part of the block 410B.

The enterprise library logging application block 410C may simplify the implementation of common logging functions. The logging application block 410C may also be used to write information to a variety of locations such as an event log, e-mail message, database, message queue, text file, windows® management instrumentation (WMI) event and custom locations using application block extension point.

The enterprise library cryptography application block 410D may provide cryptographic functionality in the applications. The applications may use the block for tasks, such as encrypting information, creating a hash from data, and comparing hash values to verify that data has not been altered. In addition, underlying providers may be changed through configuration without changing the underlying application code.

The security application block 410E may simplify encryption tasks by handling in a consistent manner, abstracting the application code from the specific security providers.

The document writer 410F of the enterprise library may be used to create or modify the documents based on template selection. The document generation capability may be implemented using openXML methodology.

The XML parser 410G of the enterprise library may be used to parse the configured XML's. The XML's may be required for document write functionality (document sections that may be configured through an XML for each template type).

The enterprise library exception handling application block 410H may create a consistent strategy for processing exceptions that occur in all architectural layers of an enterprise application. The exception handling block 410H may be designed to support the typical code contained in catch statements in the application components. Instead of repeating the code (such as code that logs exception information) in identical catch blocks throughout the application, the exception handling application block 410H allows developers to encapsulate the logic as reusable exception handlers.

The alerting block 410I may be used to send alerts like SMS or e-mail to the stakeholders and/or consultants to respond to document reviews/questionnaire completion etc.

In one or more embodiments, the external system service layer DB provider adapter 408A may be used for database operations.

The AV & messaging adapter 408B may be used to send SMS or email alerts to all stakeholders/consultants.

The file and store adapter 408C may be used for document management.

The security adapter 408D may be used for security management.

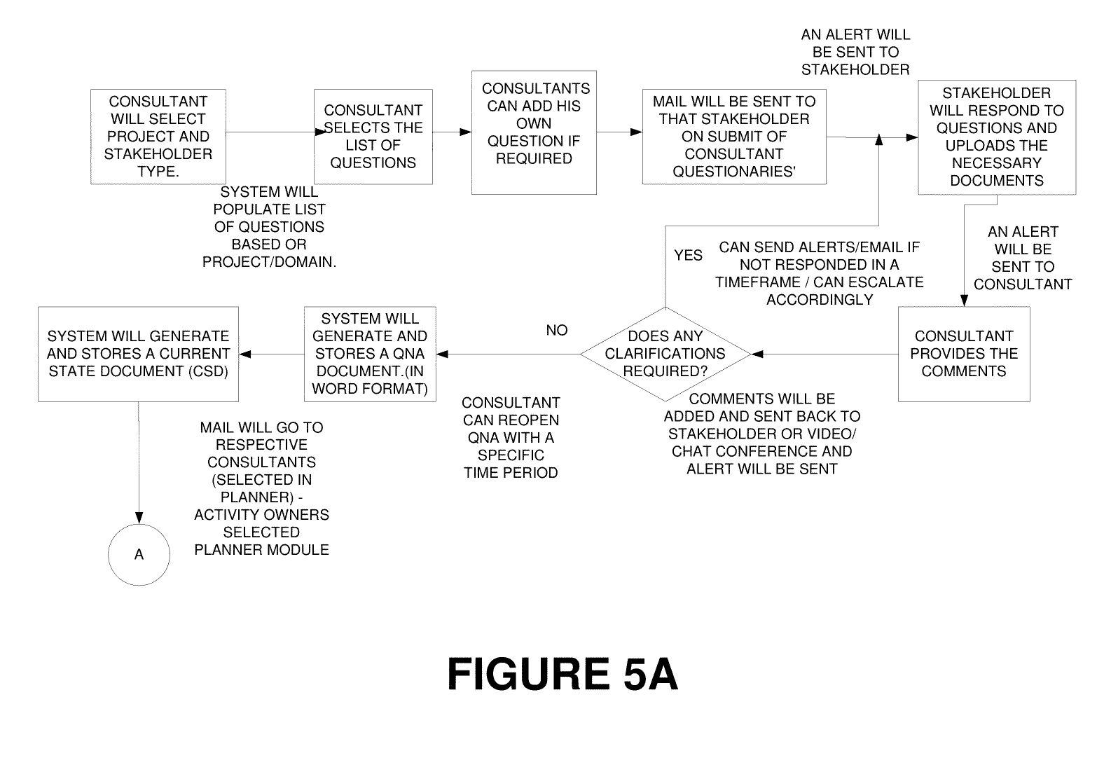

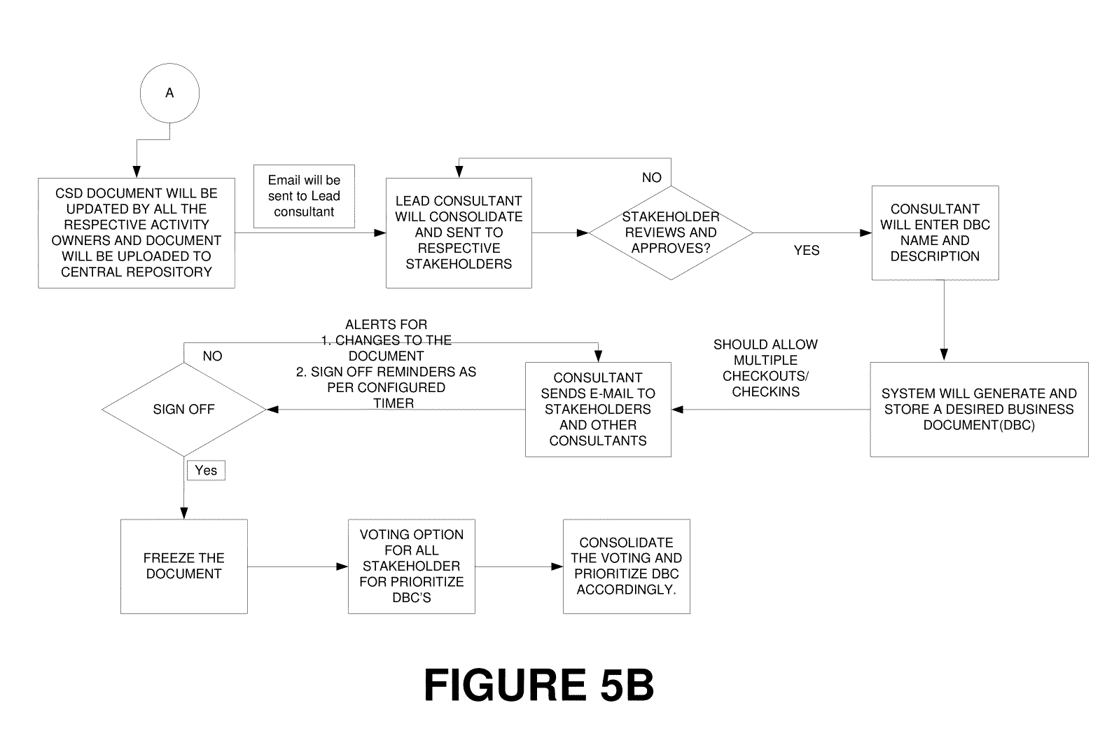

FIG. 5A and 5B. illustrate flowchart of data collection module 406C. Beginning with, the consultant will select the project and stakeholder type. The consultant selects list of questions and may also add questions to the list if required. The list of questions may be sent to the stakeholders through email. The stakeholders respond and/or provide comments to the questions. If there are any clarifications, comments will be added and sent back to the stakeholder. Else, Q&A and customer specification document (CSD) document may be generated. The CSD document may be updated by respective process or activity owner and uploaded to the central repository. An email may be sent to lead consultant. Post stakeholder review and approval, the consultant may enter DBC name and description for final sign-off. The DBC document may be finalized and consolidated after voting and prioritizing DBC's accordingly by the consultant.

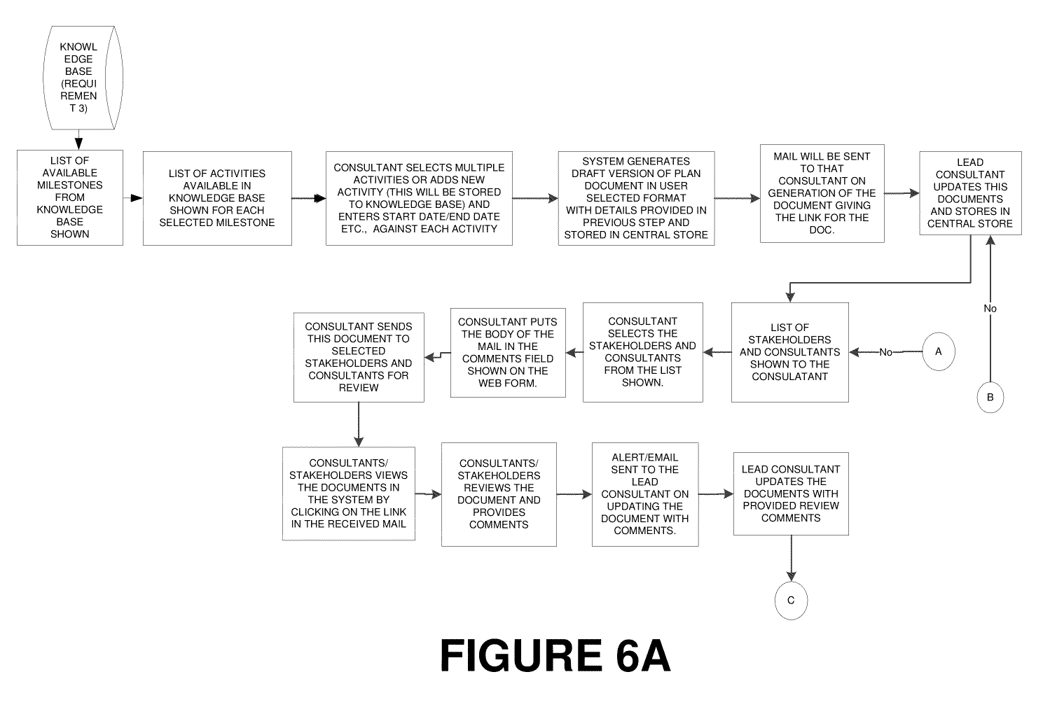

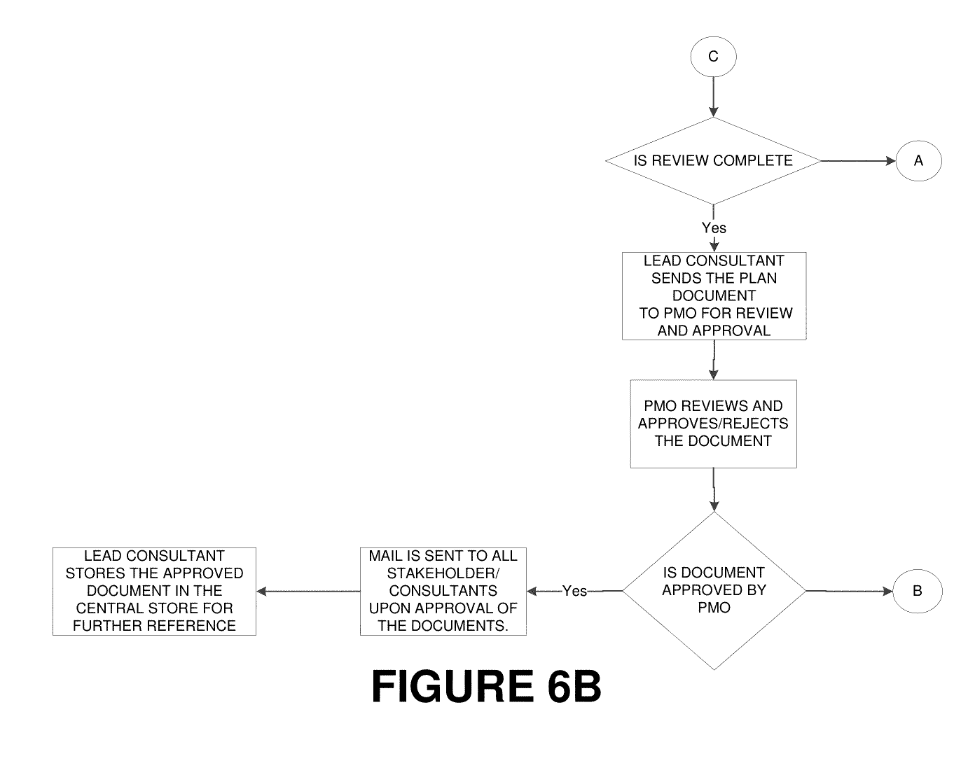

FIG. 6A and 6B. illustrate flowchart of planner module 406G. The flowchart shows list of milestones available and list of activities available for selected milestone. The consultant may select multiple activities or add new activities and may enter start/end date for each activity shown. The consulting system 100 may generate draft planner document and save in central repository providing the link to the document to respective consultant via email. The consultant sends the document to selected stakeholder for review. The stakeholders review the document and provide comments. The consultant updates the document with review comments. Post review and update, the consultant sends the document for project management officer (PMO) approval. Post PMO approval, the approved document may be stored in the central repository for further reference.

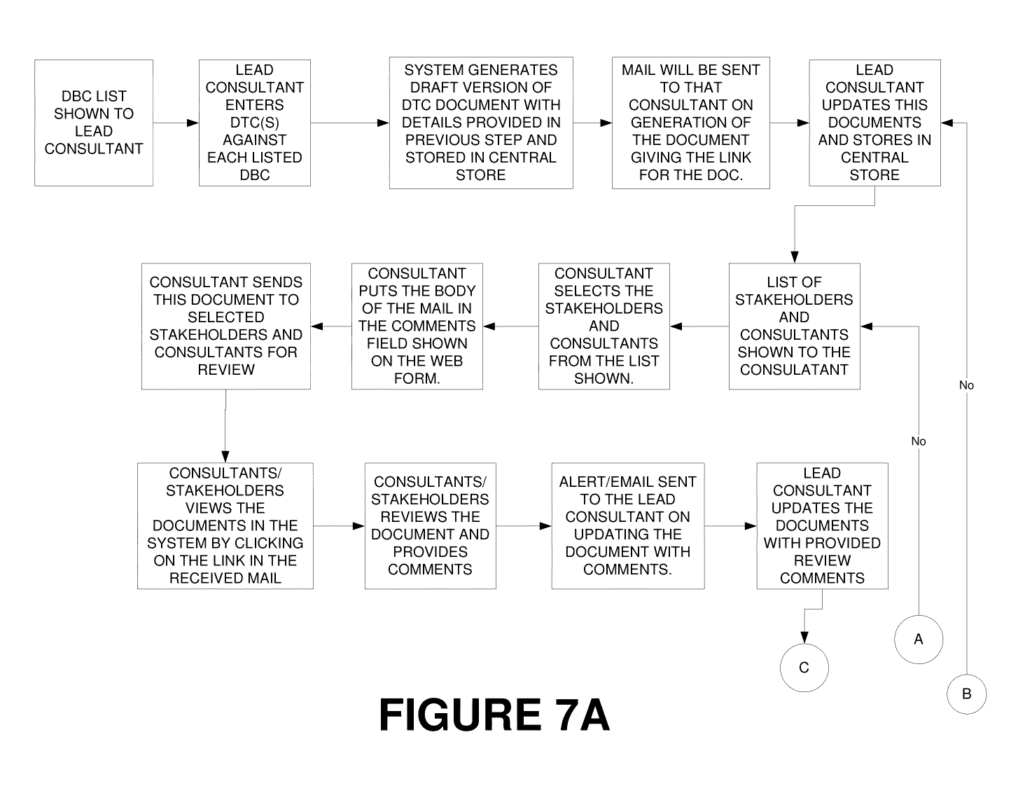

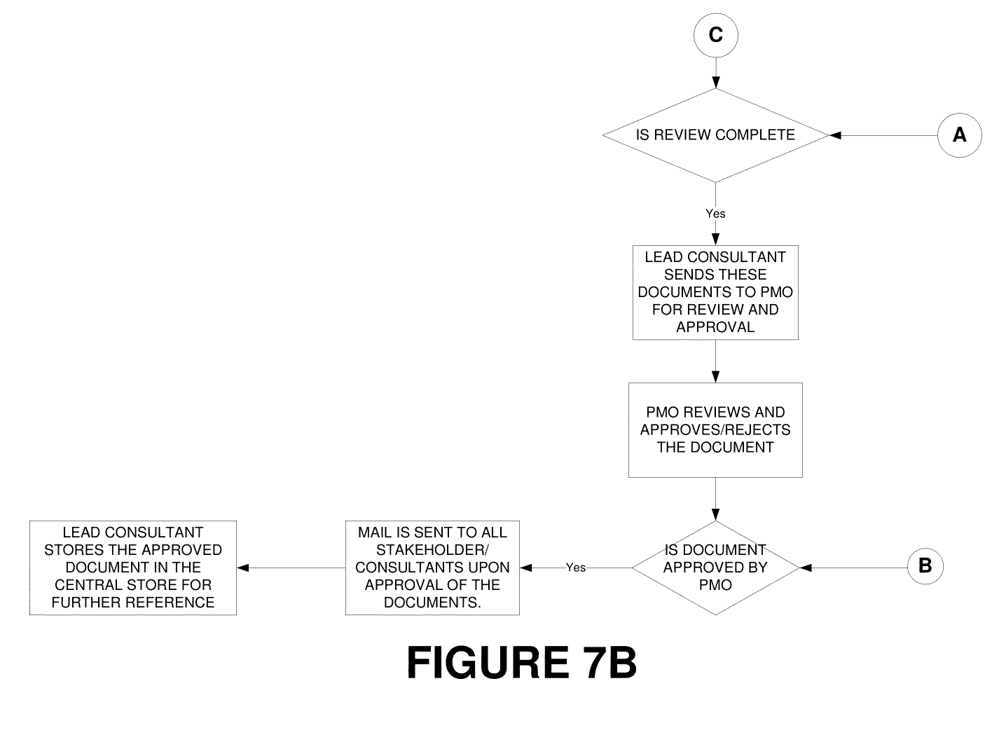

FIG. 7A and 7B illustrate flowchart of analysis module 406H. The DBC document may be shown to the lead consultant. The lead consultant may enter desired technical capabilities (DTC) against each DBC. The draft version of DTC document may be generated and stored in central repository providing the link to the document to respective consultant via email. The consultant sends the document to selected stakeholder for review. The stakeholder reviews the document and provides comments. The consultant updates the document with review comments. Post review and update, the consultant sends the document for PMO approval. Post PMO approval, the approved document may be stored in central repository for further reference and could be used as RFP inputs.

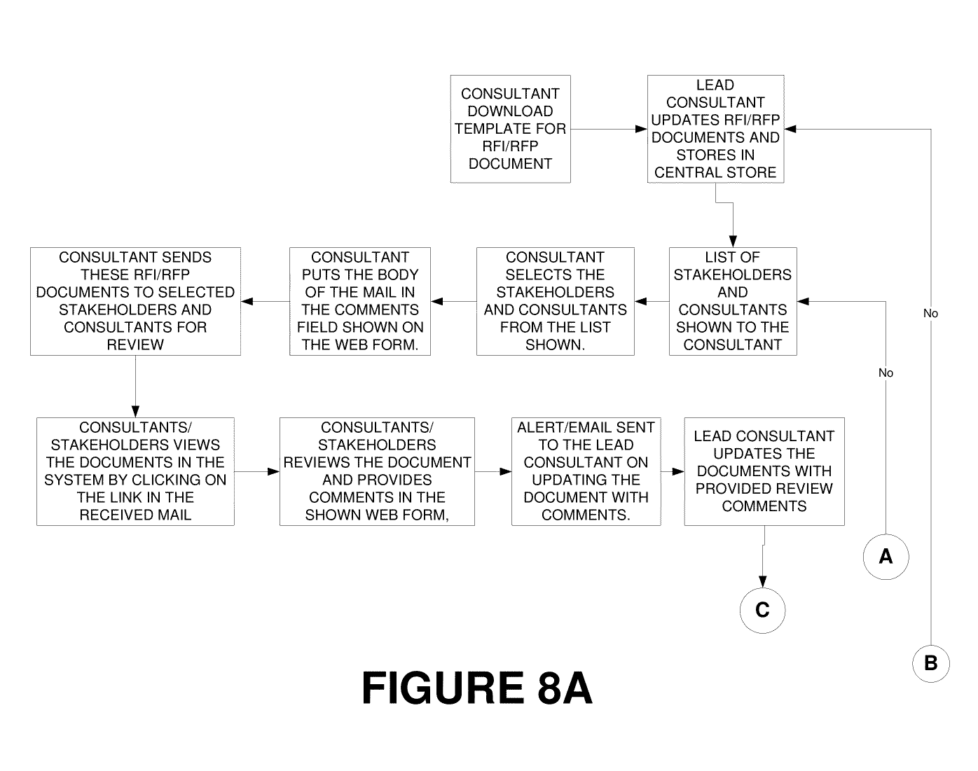

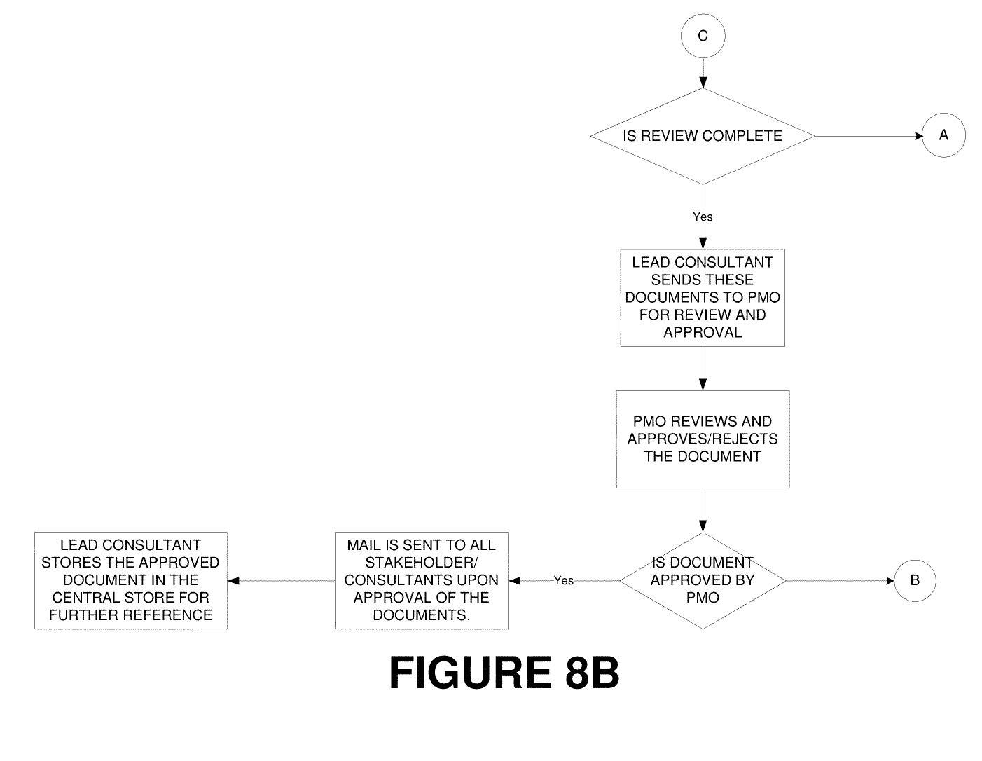

FIG. 8A and 8B illustrate flowchart of RFP creation module 406D. The consultant may download template from knowledgebase 406E for the RFI/RFP document. The consultant updates the RFI/RFP document and stores in the central repository. The consultant sends the document to selected stakeholder for review. The stakeholders review the document and provide comments. The consultant updates the document with review comments. Post review and update, the consultant sends the document for PMO approval. Post PMO approval, the approved document may be stored in the central repository for further reference.

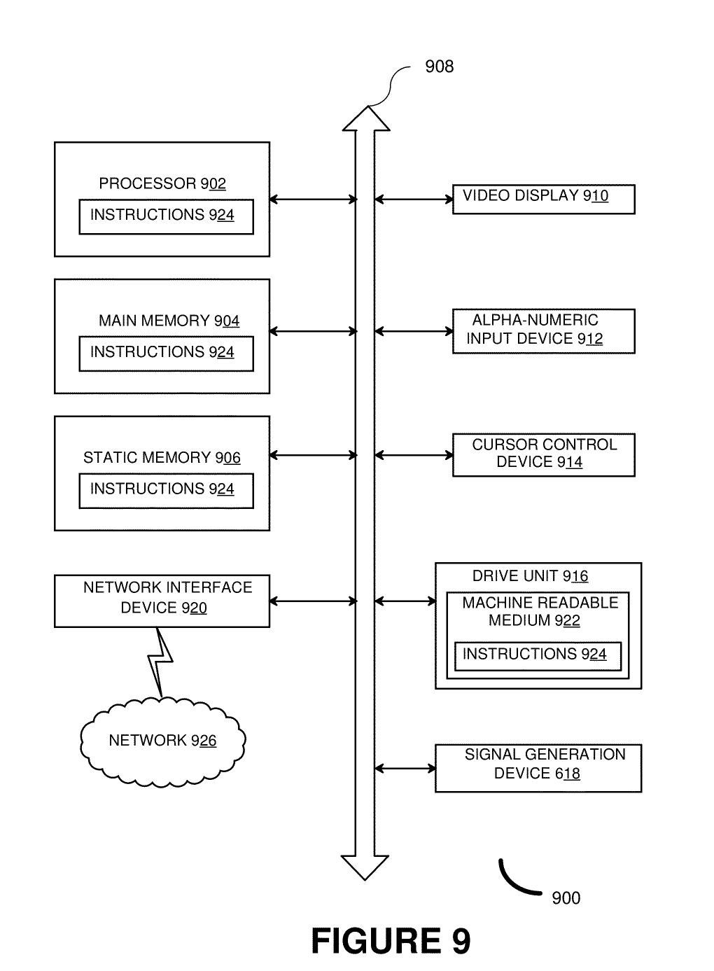

FIG. 9 is a diagrammatic representation of a data processing system capable of processing a set of instructions to perform any one or more of the methodologies herein, according to an example embodiment. FIG. 9 shows a diagrammatic representation of machine in the example form of a computer system 900 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and or as a peer machine in a peer-to-peer (or distributed) network environment. The machine may be a personal—computer (PC), a tablet PC, a set-top box (STB), a Personal Digital Assistant (PDA), a cellular telephone, a web appliance, a network router, switch and or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 900 includes a processor 902 (e.g., a central processing unit (CPU) a graphics processing unit (GPU) and/or both), a main memory 904 and a static memory 906, which communicate with each other via a bus 908. The computer system 900 may further include a video display unit 910 (e.g., a liquid crystal displays (LCD) and/or a cathode ray tube (CRT)). The computer system 900 also includes an alphanumeric input device 912 (e.g., a keyboard), a cursor control device 914 (e.g., a mouse), a disk drive unit 916, a signal generation device 918 (e.g., a speaker) and a network interface device 920.

The disk drive unit 916 includes a machine-readable medium 922 on which is stored one or more sets of instructions 924 (e.g., software) embodying any one or more of the methodologies and/or functions described herein. The instructions 924 may also reside, completely and/or at least partially, within the main memory 904 and/or within the processor 902 during execution thereof by the computer system 900, the main memory 904 and the processor 902 also constituting machine-readable media.

The instructions 924 may further be transmitted and/or received over a network 926 via the network interface device 920. While the machine-readable medium 922 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical media, and magnetic media.

What is claimed is:

1. A computer-implemented consulting system comprising: a processor, and instructions stored in a memory, wherein the instructions are adapted to cause the processor to perform:
receive an input of a domain from a user of the consulting system;
select a methodology for consulting activity based on the domain input;
receive weighted parameters related to a business from at least one stakeholder through a predefined questionnaire, wherein allowing the user to configure vendor evaluation parameters and associated weightages;
calculate a gap between a current state and desired state of the business based on the received parameters;
identify a set of technical requirements to generate a request for proposal based on the calculated gap; and
assess the at least one vendor by assigning a score based on the weighted parameters received from at least one stakeholder.

2. The system of claim 1 further comprises instructions that cause the processor to: provide the user with an option to perform cost benefit analysis by comparing different vendors.

3. The system of claim 1, further comprises:
a repository of all consulting methodologies with a list of pre-defined questionnaire and document templates.

4. The system of claim 1 further comprises instructions that cause the processor to: integrate with social media, email, SMS, fax and chat through web using media integration means.

5. The system of claim 1 further comprises instructions that cause the processor to: store sensitive data in a database using secured encrypted storage mechanism.

6. The system of claim 1 further comprises instructions that cause the processor to: manage access and authenticate users using authentication and authorization means.

7. The system of claim 1 further comprises user configurable accounts.

8. The system of claim 1 further comprises instructions that cause the processor to: support at least one of a hosted and in premise solution.

9. The system of claim 1 further comprises instructions that cause the processor to: automate consultation activity by reducing the time taken.

10. A method comprising:
receiving an input of a domain from a user of a consulting system;
selecting a methodology for consulting activity based on the domain input;
receiving weighted parameters related to a business from at least one stakeholder through a predefined questionnaire, wherein allowing the user to configure vendor evaluation parameters and associated weightages;
calculating a gap between a current state and desired state of the business based on the received parameters;
identifying a set of technical requirements to generate a request for proposal based on the calculated gap; and
assessing the at least one vendor by assigning a score based on the weighted parameters received from at least one stakeholder.

11. The method of claim 10 further comprising: providing the user with an option to perform cost benefit analysis by comparing different vendors.

12. The method of claim 10 further comprising: integrating with social media, fax and chat through web using media integration means.

13. The method of claim 10 further comprising: storing sensitive data in a database using secured encrypted storage mechanism.

14. The method of claim 10 further comprising: managing access and authenticating users using authentication and authorization means.

15. The method of claim 10 further comprising: configuring user accounts.

16. The method of claim 10 further comprising: supporting at least one of a hosted and in premise solution.

17. The method of claim 10 further comprising: automating consultation activity by reducing the time taken.

18. One or more non-transitory computer-readable media comprising instructions that when executed by a computing system cause the computing system to perform a method comprising:
receiving an input of a domain from a user of the consulting system;
selecting a methodology for consulting activity based on the domain input;
receiving weighted parameters related to a business from at least one stakeholder through a predefined questionnaire, wherein allowing the user to configure vendor evaluation parameters and associated weightages;
calculating a gap between a current state and desired state of the business based on the received parameters;
identifying a set of technical requirements to generate a request for proposal based on the calculated gap; and
assessing the at least one vendor by assigning a score based on the weighted parameters received from at least one stakeholder.
